(19) United States
(12) Patent Application Publication
(10) Pub. No.: US 2014/0166644 A1
(43) Pub. Date: Jun. 19, 2014

(54) RADIATION-SHIELDING CONTAINER

(71) Applicants: Alan Troy Hale, Irvine, CA (US); Jakob Bredsguard, Lake Forest, CA (US); Dalin Winters, Burlington, WY (US)

(72) Inventors: Alan Troy Hale, Irvine, CA (US); Jakob Bredsguard, Lake Forest, CA (US); Dalin Winters, Burlington, WY (US)

(21) Appl. No.: 14/083,450

(22) Filed: Nov. 19, 2013

Related U.S. Application Data
(60) Provisional application No. 61/796,745, filed on Nov. 19, 2012.

(51) Int. Cl. H05B 6/64; A47J 29/02

(52) U.S. Cl. CPC H05B 6/6494; A47J 29/02
USPC 219/730; 219/712; 99/336

(57) ABSTRACT

Systems and methods are disclosed for heating substances in a microwave oven. A container structure includes an internal chamber configured to have heating contents placed therein, wherein the chamber is defined at least partially by a thermally-conductive structure. A microwave-absorbing medium is disposed in direct or indirect thermal communication with at least a portion of the thermally-conductive structure. A microwave radiation barrier is disposed between at least a portion of the microwave-absorbing medium and the internal chamber. In certain embodiments, when the container is exposed to external microwave radiation, the internal chamber is substantially shielded from the microwave radiation.

### CROSS-REFERENCE TO RELATED APPLICATIONS

This application claims priority to U.S. Provisional Application No. 61/796,745 filed Nov. 19, 2012, entitled RADIATION-SHIELDING CONTAINER, the disclosure of which is hereby expressly incorporated by reference herein in its entirety.

### BACKGROUND

1. Field

The present invention generally relates to food containers, and more specifically to food containers for use in connection with radiation-heating devices.

2. Description of Related Art

Certain radiation heating devices, such as microwave ovens, heat food by dielectric heating. This is accomplished with radiation used to heat polarized molecules in food or other substances.

### SUMMARY

Certain embodiments disclosed herein provide a container including an electrically-conductive inner cup having a sidewall portion and a base portion and an outer cup configured to be connected to the inner cup, thereby forming an outer chamber between an inside surface of the outer cup and an outside surface of the sidewall portion of the inner cup. The container may further include a lid including an electrically-conductive portion, wherein the lid and inner cup form an interior chamber and provide an electromagnetic radiation barrier substantially preventing radiation from a microwave oven from entering the interior chamber when the lid is positioned on the inner cup.

In certain embodiments, the outer chamber is configured to receive a microwave-absorbing medium in direct or indirect thermal communication with the sidewall portion, wherein the microwave-absorbing medium is configured to generate thermal energy in response to exposure to microwave radiation of a first power level and a first frequency. The microwave-absorbing medium may include water. Furthermore, the microwave-absorbing medium may include a sodium compound which increases a boiling point of the microwave-absorbing medium. The microwave-absorbing medium may comprise liquid. In certain embodiments, the microwave-absorbing medium includes oil. In certain embodiments, the microwave-absorbing medium includes solid material.

In certain embodiments, the lid comprises one or more apertures that allow air to pass out of the internal chamber. The inner cup may have a substantially elliptical cross-section. In certain embodiments, the outer cup has a thermal conductivity of greater than approximately 2 W/mK. For example, the outer cup may include silicone.

The inner cup may include one or more inwardly-projecting heat fins. In certain embodiments, at least a portion of an inside surface of the inner cup has a high-emissivity coating disposed thereon. The heat transfer medium may include phase-change material. In certain embodiments, the outer cup includes a pour spout.

Certain embodiments disclosed herein provide a process of heating a substance including exposing a container to microwave radiation, wherein the container includes an inner cup containing heating contents in direct physical contact with a sidewall portion of the inner cup and a chamber containing a heat transfer medium in direct physical contact with the sidewall portion. The process may further include heating the heat transfer medium with the radiation, preventing the radiation from penetrating the heating contents, and heating the contents through the sidewall using the heated heat transfer medium.

Heating the contents through the sidewall may involve convectively heating the contents using the heat transfer medium in a boiling state. The process may further include heating the contents through a base portion of the inner cup.

Certain embodiments disclosed herein provide an egg-poaching container for use in a microwave oven including a electrically-conductive inner cup having a sidewall portion and a base portion and a substantially non electrically conductive outer cup configured to nestingly receive the inner cup, thereby forming an outer chamber between an inside surface of the outer cup and an outside surface of the sidewall portion of the inner cup. The container may further include a lid including an electrically-conductive portion, wherein the lid and inner cup form an interior chamber and provide an electromagnetic radiation barrier substantially preventing radiation from a microwave oven from entering the interior chamber when the lid is positioned on the inner cup. In certain embodiments, the outer cup and inner cup are configured to be disconnected from one another, thereby allowing for a heat transfer medium to be deposited in the outer cup. The outer cup may further include a vent aperture therein for venting gaseous heat transfer medium when the inner cup is nested in the outer cup.

### BRIEF DESCRIPTION OF THE DRAWINGS

The following drawings and the associated descriptions are provided to illustrate embodiments of the present disclosure and do not limit the scope of the claims. Throughout the drawings, similarities or re-use of reference numbers may indicate correspondence between referenced elements.

FIGS. 1A-1B are block diagrams illustrating embodiments of radiation shielding containers;

FIGS. 2A-2B are block diagrams illustrating embodiments of radiation shielding containers;

FIGS. 2C-2D are block diagrams illustrating embodiments of radiation shielding containers including lid portions;

FIG. 3 is a block diagram illustrating thermal transfer to heating contents in a radiation shielding container;

FIG. 4A is a perspective view of an embodiment of an internal chamber of a radiation shielding container;

FIG. 4B is a close-up view of a portion of the internal chamber of FIG. 4A;

FIGS. 5A-5C are top views of embodiments of internal chambers of radiation shielding containers;

FIG. 6 is a cross-sectional side view of an embodiment of an internal chamber of a radiation shielding container;

FIG. 7 is a perspective view of an embodiment of an internal chamber associated with a radiation barrier;

FIG. 8 is a close-up view of a portion of an embodiment of a radiation barrier having openings therein;

FIG. 9 illustrates a perspective cut-away view of an embodiment of a bottle having radiation-shielding characteristics.

FIG. 10 is a cross-sectional view of a baby bottle embodiment having an insulator portion associated with at least a portion of the exterior of the bottle;

FIG. 11 illustrates a perspective view of an embodiment of an egg-poaching container in accordance with certain features disclosed herein.

FIG. 12 illustrates a perspective view of an embodiment of a rectangular food-poaching container in accordance with certain features disclosed herein.

FIG. 13 illustrates a perspective view of components of an embodiment of a radiation-shielding container.

FIGS. 14A-14D illustrate various views of an outer cup portion of a radiation-shielding container according to one or more embodiments.

FIGS. 15A-15D illustrate various views of an inner cup portion of a radiation-shielding container according to one or more embodiments.

FIGS. 16A-16B illustrate top and side views of a lid portion of a radiation-shielding container according to one or more embodiments.

### DETAILED DESCRIPTION

Although certain preferred embodiments and examples are disclosed herein, inventive subject matter extends beyond the specifically disclosed embodiments to other alternative embodiments and/or uses of the inventions, and to modifications and equivalents thereof. Thus, the scope of the inventions herein disclosed is not limited by any of the particular embodiments described below. For example, in any method or process disclosed herein, the acts or operations of the method or process may be performed in any suitable sequence and are not necessarily limited to any particular disclosed sequence.

For purposes of contrasting various embodiments with the prior art, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Various methods exist for heating substances, such as food. For example, certain types of radiation can be used in heating, wherein a substance is at least partially exposed to energetic particles or waves traveling through a medium or space which transfer energy to the substance. Microwave ovens are a common example of a device utilizing radiation-heating technology for heating of foods and other substances. Microwaves provide a number of benefits over certain other heating methods. For example, microwaves can provide relatively quick heating when compared to stove-top or oven cooking under certain conditions. Microwave ovens generally operate by passing non-ionizing microwave radiation, usually at a frequency of 2.45 gigahertz (GHz)—a wavelength of 122 millimeters (4.80 in)—through food in an internal cooking chamber.

Microwave radiation is between common radio and infrared frequencies. Water, fat, and other content in food or other substances may absorb energy from the microwaves, depending on wavelength, in a process called dielectric heating. Certain molecules (such as those of water) are electric dipoles, wherein the molecules have a partial positive charge at one end and a partial negative charge at the other, and as a result may rotate as they try to align themselves with an alternating electric field presented by microwave radiation. Rotating molecules can contact other molecules and put them into motion, thus dispersing energy. This energy, when dispersed as molecular vibration in solids and liquids (e.g., as both potential energy and kinetic energy of atoms), may represent heat, or thermal energy. Therefore, under certain conditions, foods containing water and/or other microwave-responsive electric dipoles can be heated when exposed to microwave radiation at various frequencies and/or power levels. The depth of initial heat deposition may be several centimeters or more, depending on water content.

In addition to water, certain fats and oils can also absorb microwaves due to the dipole moments of their hydroxyl groups or ester groups. Furthermore, due to potentially lower specific heat capacity and/or higher vaporization temperature, certain fats and oils may attain relatively high temperatures inside microwave ovens. This may induce temperatures in certain oils or fatty substances (e.g., bacon) above the boiling point of water.

For various reasons, including health reasons, microwaves are generally constructed in such a way to prevent microwave radiation from exiting the cooking chamber. Internal components of the microwave can provide microwave shielding functionality to such end. In certain embodiments, the cooking chamber substantially forms a Faraday cage, which acts to contain the microwaves introduced into the chamber. A Faraday cage is an enclosure that may be formed by electrically-conductive material, such as a sheet, a mesh or perforated sheet of such material. Such an enclosure may block external static and/or non-static electric fields under certain conditions. In a Faraday cage, an external static electrical field causes electric charges within the cage's conducting material to redistribute themselves so as to at least partially cancel the field's effects in the cage's interior. Generally, Faraday cages may shield interior contents from external electromagnetic radiation if the conductor is thick enough and any holes or gaps are significantly smaller than the wavelength of the radiation. Therefore, a Faraday cage may be configured to at least partially block external microwave radiation from affecting contents contained within the cage.

On one side, a microwave oven wall may be formed at least partially by a portion of the microwave door. As it is often desirable to view internal contents of a microwave while the microwave door is shut, microwave ovens generally are configured with a viewing window. While such a window allows visible light to propagate therethrough, thereby allowing for external visibility of the microwave contents, for reasons discussed above, it is desirable for the window to incorporate microwave radiation-shielding functionality. A microwave oven door may include a layer of conductive mesh to maintain the shielding. Such mesh often takes the form of a sheet of perforated metal, wherein the perforations are large enough to provide visibility through the sheet, but small enough to substantially prevent microwave radiation from passing through the sheet (microwaves have longer wavelength than visible light, and therefore cannot pass through the sheet in certain configurations).

One potential benefit of microwave heating over certain other heating methods may be tied to a microwave oven's ability to heat food without getting hot itself. The internal walls of a microwave oven do not substantially absorb microwave radiation, and therefore, are not heated when exposed to the same. For example, taking a pot off a stove, with the exception of possibly an induction cooktop, can leave a potentially dangerous heating element that can stay hot for some time. Likewise, when taking a dish out of a conventional oven, a user's arms and/or other members may generally be exposed to the substantially hot walls of the oven. Furthermore, heat from a stove or oven can dissipate into the surrounding environment, leading to possibly undesirable heating outside of the oven or stove area. Microwave ovens generally do not pose such potential problems. Furthermore, food contents cooked in an oven or on a stove in some cases can reach temperatures significantly greater than the boiling point of water. Overheated food or other heated contents can lead to severe burns, property damage, and can even cause fires or other potentially damaging effects. Because heating temperature may be limited in some respect by the boiling point of water, microwave ovens, and other boiling-water cooking methods may provide more controlled cooking according to certain measures.

Food and cookware taken out of a microwave oven are rarely substantially hotter than 100° C. (212° F.). Furthermore, cookware used in a microwave oven is often much cooler than its contents because the cookware may be transparent to microwaves; the microwaves heat the food directly, while the cookware may be only indirectly heated by the food. Food and cookware from a conventional oven, on the other hand, are generally approximately the same temperature as the rest of the oven; a typical cooking temperature may be 180° C. (356° F.). Therefore, handling of cookware from conventional stoves and ovens may present greater danger of burns. In microwave ovens, a lower temperature of cooking (generally limited by the boiling point of water), coupled with at least partially microwave-transparent cookware may provide a significant safety benefit compared to baking in the oven or frying, because lower temperatures may have less potential to burn. In addition, lower cooking temperature of microwaves may at least partially prevent the formation of tars and char, which are carcinogenic, as can form from certain other heating methods.

As described above, it may be desirable for a container to be at least partially transparent to microwave radiation. Therefore, containers used in microwave ovens that contact contents to be heated may advantageously be “microwave safe” containers. That is, the container is comprised of material that does not substantially absorb microwave radiation. For example, when a container contains some amount of water content, or other material having electric dipoles reactive to microwave radiation, some amount of the microwave radiation exposed to the container will be absorbed by the container itself, rather than the contents of the container. Such absorption may cause unsafe or otherwise undesirable heating of the container, leading to burns to a user from physical contact or other adverse consequences. For example, certain plastics and other materials can leach into internal container contents when heated to undesirable levels, adversely affecting health, taste and/or other characteristics associated with consumption of such contents.

### Microwave Hot Spots

Certain substances heated in microwave ovens can result in uneven distribution of thermal energy within the substance. For example, in non-uniformly-structured or non-homogenous food items, microwaves may be absorbed in an uneven fashion, producing “hot spots,” and/or other undesirable characteristics in the food. Hot spots can be undesirable for a number of reasons. For example, a substance that is heated unevenly, particularly when hot spots are present below a surface of the substance, may be hotter than perceived or expected in certain regions. With respect to baby foods, such as bottled formula or breast milk, buried hot spots in the food can present danger of potential harm from burns or other heat-related discomfort. A parent may test the temperature of such a food by placing an amount of the food in contact with a portion of the parent's skin. However, if the food is unevenly heated, contact with the food may provide misrepresentation of the maximum heat of the food. Furthermore, with respect to certain substances, it may be undesirable to shake or otherwise agitate the substance for the purpose of mixing the contents to reduce hot spots. For example, agitation of breast milk, as well as certain other nutritious substances, may cause a break down of proteins and/or other nutrients present in the substance. Nutrition is often a significant motivating factor for choosing to feed a child breast milk as opposed to alternative potential sources of nutrition. Therefore, shaking a bottle of breast milk may be undesirable.

In a microwave oven, the relatively short cooking duration may contribute to uneven cooking because heat requires time to diffuse through food, and microwaves only penetrate to a limited depth. Uneven heating in microwaved food can be partly due to the uneven distribution of microwave energy inside the oven, and partly due to the different rates of energy absorption in different parts of the food. Microwaves often utilize a turntable or carousel that turns the food for the purpose of promoting even heating; turntables, however, may still leave spots, such as the center of the oven, which receive uneven energy distribution.

Another case of uneven heating can be observed in certain foods having a composition comprising mixed contents, wherein one portion of the food has high-absorption characteristics, while a surrounding portion of the food has low-absorption, low-heat conduction/dissipation characteristics. The highly-absorptive contents can heat significantly in the presence of microwave radiation, which heat is unable to dissipate in the surrounding portion, and therefore may cause overheating of the highly-absorptive contents relative to other portions of the food.

Problems associated with uneven cooking in microwaves may be addressed in a number of ways. For example, problems caused by food composition and geometry may be at least partially alleviated by arranging the food so that it absorbs energy evenly, and/or periodically testing and shielding portions of the food that overheat. While such measures may at least partially alleviate problems associated with uneven cooking, they can be cumbersome, time consuming, and at least partially defeat some of the advantages of convenience generally associated with use of microwave ovens. Furthermore, in some materials with low thermal conductivity, where dielectric constant increases with temperature, microwave heating can cause localized thermal runaway.

### Effects of Microwave Radiation on Nutrients

In addition to risk of injury, microwave heating can pose various health-related concerns. The resonation of water molecules within food at high frequency may cause a change in the food's chemical structure, possibly destroying desirable nutrients contained therein. It is believed that microwaving can convert vitamin B12, which can be significant for red blood cell formation, preventing anemia, and a healthy nervous system, from an active to inactive form. The amount inactivated may depend on certain factors, such as the temperature reached, as well as the cooking time. Whereas boiled food reaches a maximum of 100 degrees centigrade (the boiling point of water), microwaved food can get focally hotter than this, leading to faster breakdown of vitamin B12. Furthermore, microwaving food may decrease flavonoids substantially, such as by up to 95% or more. Flavonoids have anti-inflammatory, anti-cancer, and anti-microbial properties. In addition, microwaving can lead to reduced levels of sinapic acid derivatives, which are known to scavenge for and neutralize free radicals, which are cancer-causing agents.

One example of a food substance that can be adversely affected by microwave exposure is human milk. Microwaving human milk at high temperatures has been linked to a marked decrease in activity of anti-infective agents within the milk. The breakdown of bacteria-digesting enzymes in breast milk can have an adverse effect on a baby's health because babies rely on enzymes from breast milk or other sources to establish a healthy inner ecosystem for food digestion, nutrient absorption, and protection against pathogens.

### Electrically-Conductive Objects in Microwave Ovens

Certain objects containing pointed metal, or other electrically-conductive material(s), can create an electric arc (sparks) when microwaved. This includes cutlery, crumpled aluminum foil (though not all foil use in microwaves is unsafe, see below), twist-ties containing metal wire, the metal wire carry-handles in paper Chinese take-out food containers, or almost any metal formed into a poorly conductive foil or thin wire; or into a pointed shape. Forks are a good example: the tines of the fork may respond to the electric field by producing high concentrations of electric charge at the tips. This has the effect of exceeding the dielectric breakdown of air, about 3 megavolts per meter (3×106 V/m). The air forms a conductive plasma, which is visible as a spark. The plasma and the tines may then form a conductive loop, which may be a more effective antenna, resulting in a longer lived spark. When dielectric breakdown occurs in air, some ozone and nitrogen oxides are formed, both of which are unhealthy in large quantities.

It is possible for metal objects and other electrically-conductive materials to be microwave-oven compatible. Microwaving an individual smooth metal object without pointed ends, for example, a spoon or shallow metal pan, usually does not produce sparking. Furthermore, thick metal wire racks can be part of the interior design in microwave ovens. In a similar way, the interior wall plates with perforating holes which allow light and air into the oven, and allow interior-viewing through the oven door, are all made of conductive metal formed in a safe shape. Such metal plates, or sheets, can serve as effective shields to microwave radiation, while potentially allowing for the transmission of light or certain fluids through the shield.

### Microwave Shielding Container

Certain embodiments disclosed herein provide a container configured to prevent or minimize the amount of radiation exposure of heating contents, while at least partially preserving convenience and other beneficial factors associated with microwave oven use. For example, certain embodiments of the present disclosure provide a microwavable container configured to utilize microwaves to heat a heat transfer medium used to heat an internal chamber, or chambers. The microwaves, however, are at least partially blocked from penetrating the internal chamber(s). Containers constructed in accordance with one or more embodiments disclosed herein may include one or more of the following features: an internal cooking chamber or chambers; a heat exchange surface in contact with both internal heating contents as well as a microwave-absorbing heat transfer medium external to the internal chamber; and an exterior housing or layer. Such features are discussed individually below.

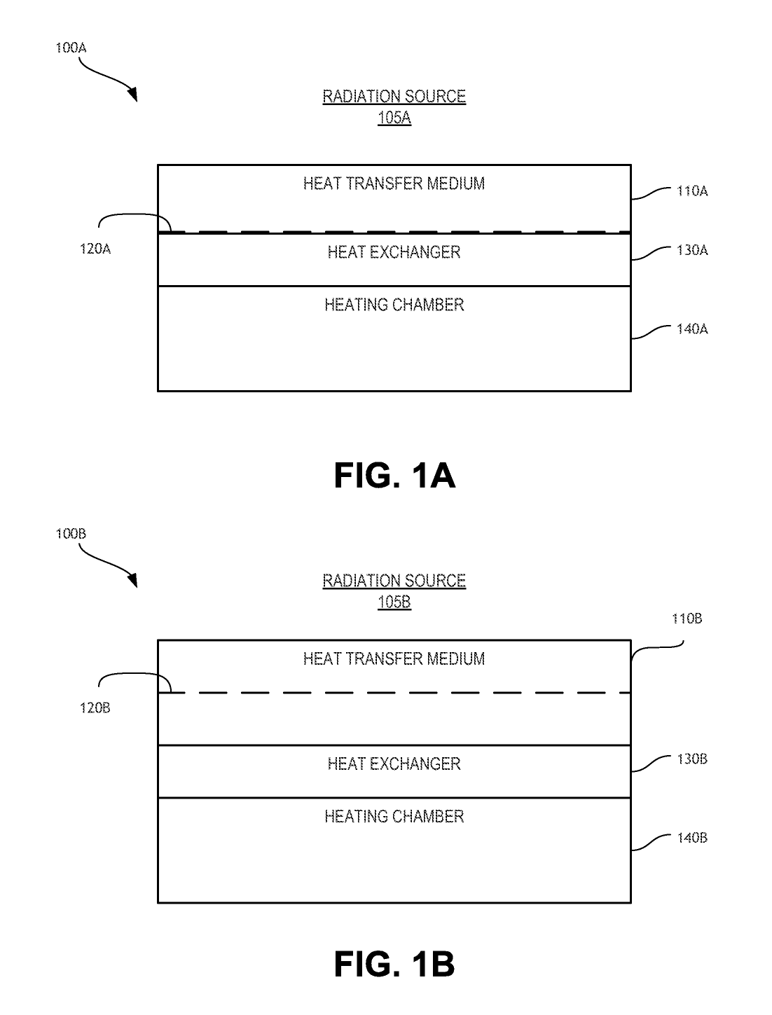

FIG. 1A illustrates a block diagram of a radiation-shielding container 100. The container includes a heat transfer medium 110A that may be exposed to radiation, such as microwave radiation. Advantageously, the heat transfer medium 110A receives thermal energy from the radiation. As described above, water or other microwave-absorbing substances present in the heat transfer medium may be heated in response to microwave radiation. The heat transfer medium 110A is disposed adjacent to a radiation shielding element 120A, such as an electrically conductive sheet or plane. In certain embodiments, the radiation shield 120 includes a metal or other conductive material having perforations, or openings therein of a size small enough to allow for electrons propagating within the material to be repositioned around such openings in order to maintain Faraday shielding characteristics. For example, such holes may be smaller, or significantly smaller, than the wavelength of the radiation, in some cases, microwaves at approximately 2.4 GHz.

The radiation shield 120A at least partially blocks the radiation from progressing past the shield. Therefore, in certain embodiments, materials or components disposed behind the radiation shield 120A with respect to the radiation source are at least partially protected from direct contact with the radiation. In the embodiment depicted in FIG. 1B, the radiation shield 120B is disposed such that at least a portion 112 of the heat transfer medium 110B is in front of the radiation shield, and at least a portion 114 is behind the shield. Therefore, at any given moment, some of the heat transfer medium may be exposed to radiation, while some is not directly exposed. In an embodiment comprising a radiation shield including perforations or openings large enough for a fluid heat transfer medium to flow through the openings, thereby allowing for thermal energy to be transferred through the radiation shield via the medium.

In FIG. 1A, the radiation shield 120A is disposed in proximity to the heat exchanger 130A. For example, the radiation shield may be a coating or layer of electrically conductive material having properties described above. As non-limiting examples, the radiation shield may comprise a metallic or other conductive paint, conductive tape or fabric, such as mesh fabric, a layer of metal secured to the heat exchanger 130A using an adhesive, such as a thermally-conductive adhesive. In certain embodiments, relatively close proximity of the radiation shield to the heat exchanger may be desirable for one or more reasons. For example, when the radiation shield is disposed in close proximity to the heat exchanger, heat that may be absorbed by the radiation shield may be more readily transferred to the heat exchanger. In certain embodiments, the radiation shield 120A and heat exchanger 130A are integrated in a substantially unitary structure. For example, the heat exchanger 130A may be configured to provide radiation shielding functionality as well as high thermal conductivity and/or emissivity.

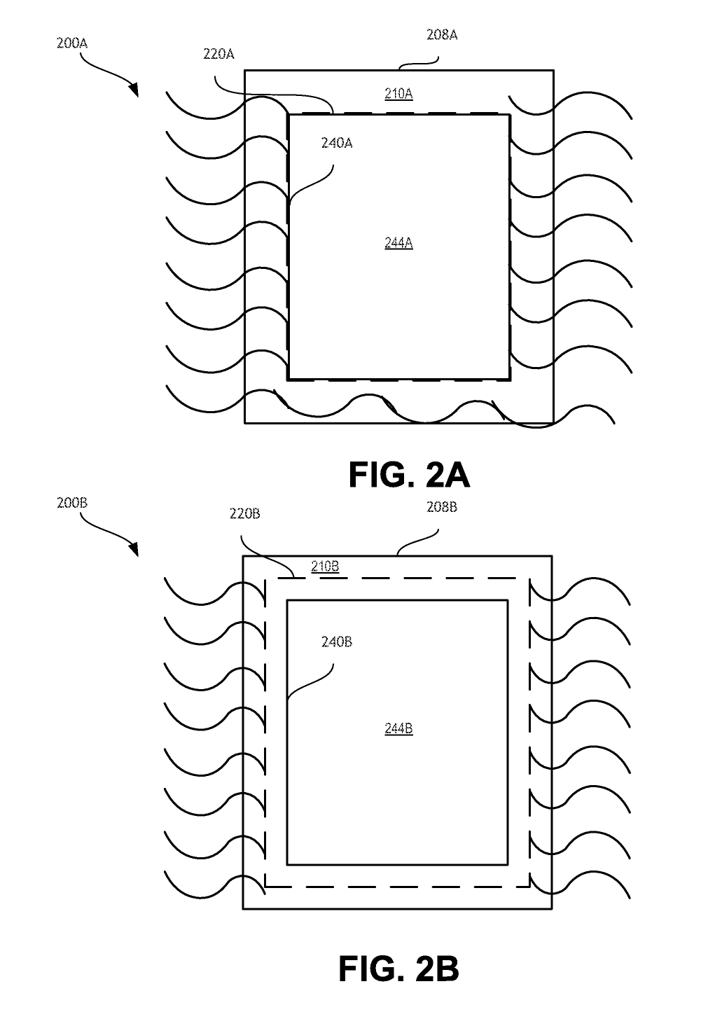

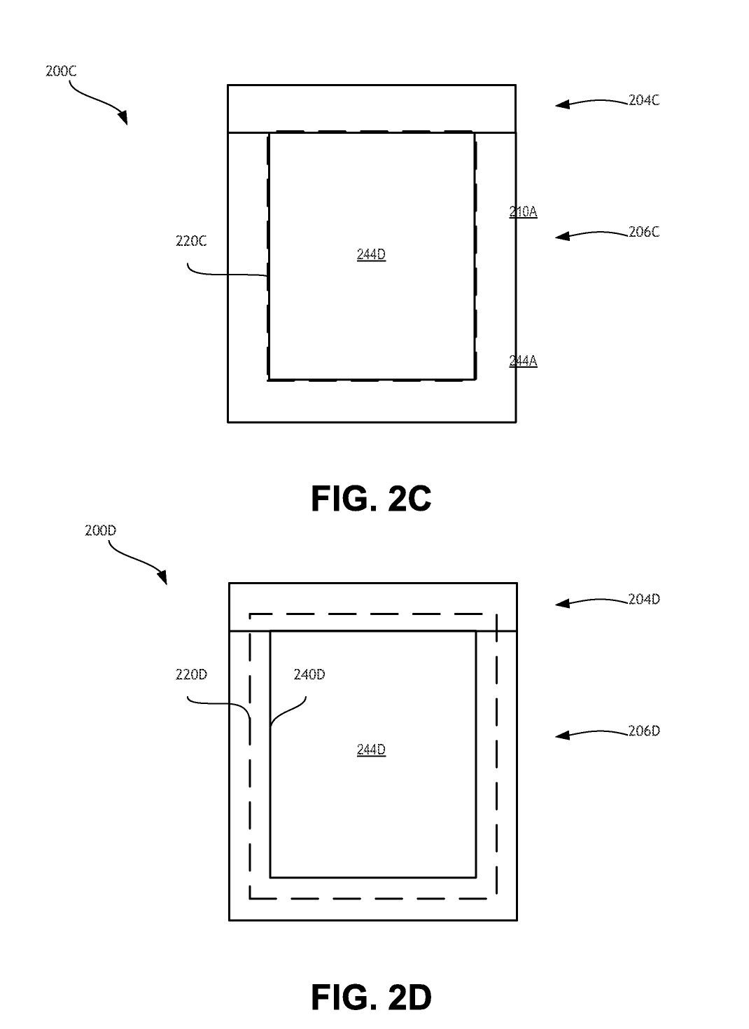

FIG. 2A illustrates a block diagram of an embodiment of radiation-shielding container 200. The container 200 may represent an embodiment of the container illustrated in FIG. 1A. The container 200A is disposed in the presence of electromagnetic radiation 201, such as microwave radiation present in an operational microwave oven. The container includes an exterior surface or structure 208A, which may be directly exposed to the radiation with respect to at least a portion of the surface or structure. In certain embodiments, the exterior surface or structure 208A is transparent, or at least partially transparent, to microwave radiation. Therefore, the radiation, as illustrated, may propagate at least to a region of the container 200A interior to the exterior structure. The region 210A may have disposed therein a radiation-absorbing substance, wherein the radiation causes thermal energy to be generated within at least a portion of the region 210A. As it may be desirable for the container to be configured to be physically handled by a user placing or retrieving the container from a microwave oven, in certain embodiments, the exterior structure 208A has thermal conduction characteristics such that the user will not sustain significant injury to burn when handling the container while at least a portion of the region 210A is hot, such as at or near the boiling point of water. In certain embodiments, the external structure comprises an amount of silicone, such as cooking-grade silicon, or other substantially thermally insulating substance, such as polypropylene.

The heat transfer medium contained in the region 210A may comprise some amount of water or other microwave-absorbing liquid or solid, such as microwave-absorbing oil or ceramic. In certain embodiments, the heat transfer medium is a volume of water, wherein the water can be heated to its boiling point when subject to microwaves of certain intensity for an adequate amount of time. The heat transfer medium may advantageously transfer heat through conduction or convection to the internal cooking chamber-defining structure 240A. Boiling of the water may incite physical movement/repositioning of water molecules as certain molecules are vaporized and matriculate to the upper surface of the volume of water. Such boiling can increase heat transfer between the heat transfer medium and the chamber structure 240A. Therefore, it may be desirable for the heat transfer medium, or region 210A in which the heat transfer medium is contained, to be relatively thin, such that it may be brought to a boil relatively quickly, thereby speeding up the heat transfer process. In certain embodiments, the heat transfer medium comprises an amount of sodium chloride (salt), or other non-volatile substance, which may increase the boiling-point temperature of the heat transfer medium. This may be desirable in order to increase the heating capacity of the heat transfer medium by allowing it to reach a temperature greater than the boiling point of water in certain regions. Furthermore, salt water may have a lower freezing point than non-salt water, which may be desirable in embodiments in which expansion of the region 210A due to freezing of water is undesirable.

The radiation is at least partially prevented from propagating to the interior chamber 244A by a radiation barrier 220A, which is described in greater detail below. It may be desirable for the radiation barrier 220A to be integrated with, or in substantial thermal communication with, the interior structure 240, such that its position between the heat transfer medium and the interior chamber does not substantially or unduly impede the transfer of thermal energy between the heat transfer medium and the internal chamber. Furthermore, the radiation barrier may advantageously be substantially thermally conductive for promoting heat transfer therethrough. As shown in the figure, the radiation may serve to heat the heat transfer medium, wherein the radiation penetrates no further than the radiation barrier 220A. Therefore, the internal contents must be heated through conduction or some other means, rather than through direct radiation heating.

The interior structure 240A may be configured to both contain internal heating contents and serve as a heat exchanger for promoting the transfer of heat from through the structure to the internal contents. The internal chamber may be configured to house liquid and/or solid contents, wherein the interior structure can transfer thermal energy to the contents, thereby heating the contents. Therefore, the contents may be heated using thermal energy at least indirectly generated by the radiation, wherein the radiation does not substantially penetrate the contents. In certain embodiments, the interior structure 240A is at least partially integrated with the radiation shield 220A.

In the embodiment of FIG. 2B, the radiation barrier 220B is disposed such that there is space between the barrier and at least a portion of the internal structure 240B. Furthermore, at least a portion of the heat transfer medium 210B is positioned between the radiation barrier 220B and the internal structure 240B. Therefore, it may be necessary or desirable for thermal energy to be transferred through the barrier to the internal portion of the heat transfer medium. Such heat transfer may be accomplished by conduction through the barrier and/or transfer of a portion of the heat transfer medium through the barrier, wherein the heat transfer medium may be heated directly by the radiation and passed through the barrier to the interior of the barrier. In certain embodiments, the heat transfer medium may pass through openings, or perforations, in the barrier, wherein the openings are configured such that the barrier may maintain at least partial radiation shielding functionality.

The embodiments of FIGS. 2C and 2D are similar in certain respects to the embodiments of FIGS. 2A and 2B, respectively, and similar reference numbers shown therein may correspond to similar or corresponding features in FIGS. 2A and 2B. The containers 200C and 200D include lid portions 204C, 204D, and body portions 206C, 206D. The lid and body portions may be separable from one another, and may accommodate the insertion of contents into the internal chamber of the container. The lid portions may comprise similar features and/or components to the body portions, as well as the components and features of the embodiments of FIGS. 2A and 2B.

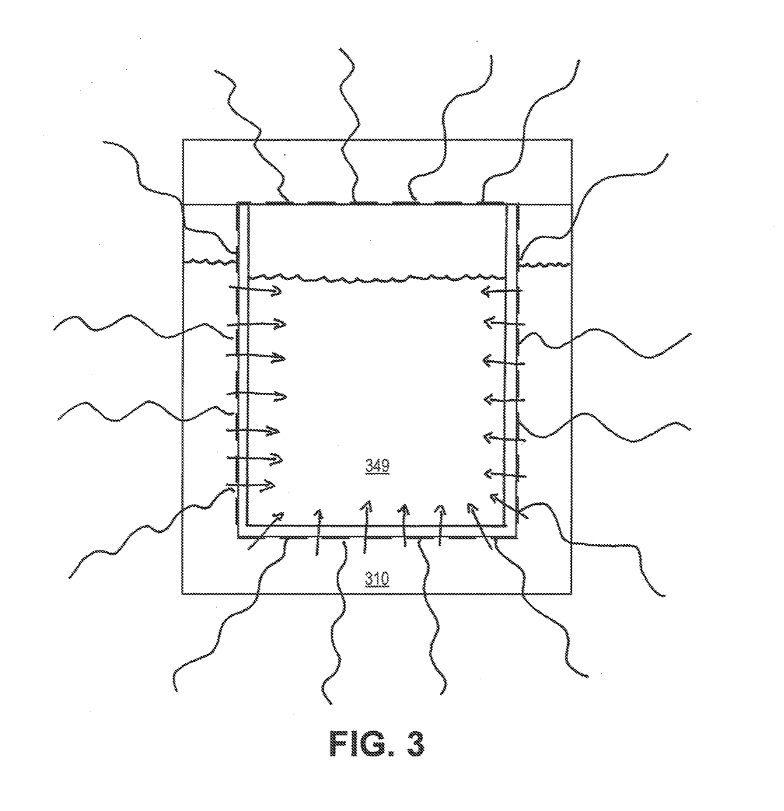

FIG. 3 is a block diagram illustrating thermal transfer to heating contents in a radiation shielding container. In certain embodiments, fluid heat transfer medium 310 is heated in the presence of microwave radiation. The container 300 may include an internal chamber containing fluid or other content 349 to be heated. A radiation barrier is positioned at least partially external to the internal chamber that impedes the traversal of the barrier by electromagnetic radiation. The internal chamber includes heat exchanging functionality allowing for an amount of heat from the heat transfer medium that is conducted to the internal chamber to transfer to the contents 439. The arrows in the figure represent paths of thermal energy transfer from the heat transfer medium to the internal contents 349. As energy is dissipated from the heat exchanger to the internal contents, thermal energy may move within the heat transfer medium towards the internal chamber in order to reach thermal equilibrium. Details of some embodiments of some of the features of the containers illustrated in FIGS. 2A-2D and FIG. 3 are described below.

### Heating Chamber

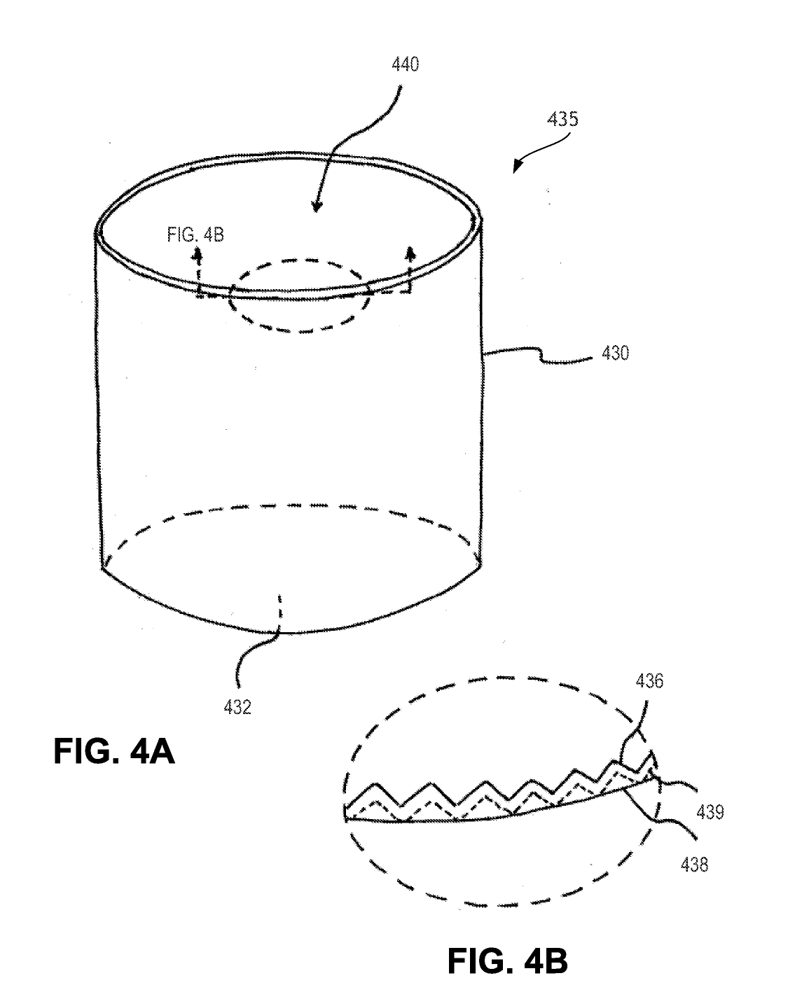

The heating chamber 140 and/or heat exchanger 130 shown in FIGS. 1A and 1B may take any suitable or desirable shape or form. In certain embodiments, a radiation shielding container advantageously includes a heating chamber structure configured to both hold fluid or non-fluid contents for heating and transfer heat to the contents, such as heat conducted from an exterior surface or region of the structure to an interior surface or region where the heat is introduced into the contents or into a matter or substance adjacent thereto. FIG. 4A illustrates an example embodiment of a heating chamber structure 435 that may serve as a component in a radiation shielding container according to one or more embodiments disclosed herein. In certain embodiments, the structure 435 is configured to hold an amount of fluid or other content when in a generally vertical orientation. The structure 435 may include one or more wall portions 430 at least partially defining a void 440 that may serve as a heating chamber. For example, contents to be heated may be placed into the chamber 440 and contained therein. The chamber may include a base portion 432 for providing a force generally normal to the heating contents and providing support thereto. In certain embodiments, the chamber structure 435 does not include a defined base portion. For example, sidewalls of the structure may join in an inverted conical apex or other shape, thereby providing under support for the heating contents.

The walls of the structure 435 may act as a heat exchanger for transferring heat into the chamber 440, and may be any desirable thickness. As described above, an outside surface of the walls 430 may come in contact with a radiation-heated medium. Therefore, it may be desirable for the walls 430 to be structured and configured to increase the rate and amount of thermal transfer through the walls to the contents contained in the chamber 440. In certain embodiments, the walls are less than about 5 mm in thickness in one or more regions. For example, one or more regions of the walls 430 may be less than about 2 mm or 3 mm. Relatively thin walls may allow for increased thermal transfer.

The heating chamber structure 435 may comprise material having relatively high thermal conductivity. While any substance capable of conducting thermal energy therethrough may be used, certain embodiments include walls or portions comprising one or more of the following materials: Aluminum, glass, brass, copper, gold, silver, or other metals or materials. In certain embodiments, the structure comprises thermally conductive plastic. Such materials may have thermal conductivity values between about 2 W/mK to 100 W/mK, or greater.

FIG. 4B provides a close-up view illustrating one or more embodiments of a top or cross-sectional portion of the wall 430. In certain embodiments, at least a portion of the wall 430 and/or base 432 comprises a substantially flat or planar surface. Alternatively, or additionally, one or more portions of the structure 435 may comprise a non-planar surface, wherein such surface presents a greater surface area than a flat/planar surface. Such increased surface area may provide increased heat transfer capacity by increasing the surface area from which heat may be absorbed or dissipated by the structure. For example, an interior surface, or other surface, may comprise a zigzag or other non-planar shape. In certain embodiments, as shown in the figure, one surface 436 of the structure is non-planar, while at least a portion of an opposite surface 438 is substantially planar, or differently shaped than the surface 436. Including at least one planar or sufficiently smooth surface may allow for disposition thereon or a conductive radiation shielding layer, wherein such layer may be disposed within a microwave oven without sparking caused by current impedance or charge collection, as described herein. In certain embodiments, both interior and exterior surfaces are non-planar in one or more portions. For example, as illustrated by the dashed line 439, both surfaces may be zigzag or other-shaped, and may comprise a similar shape.

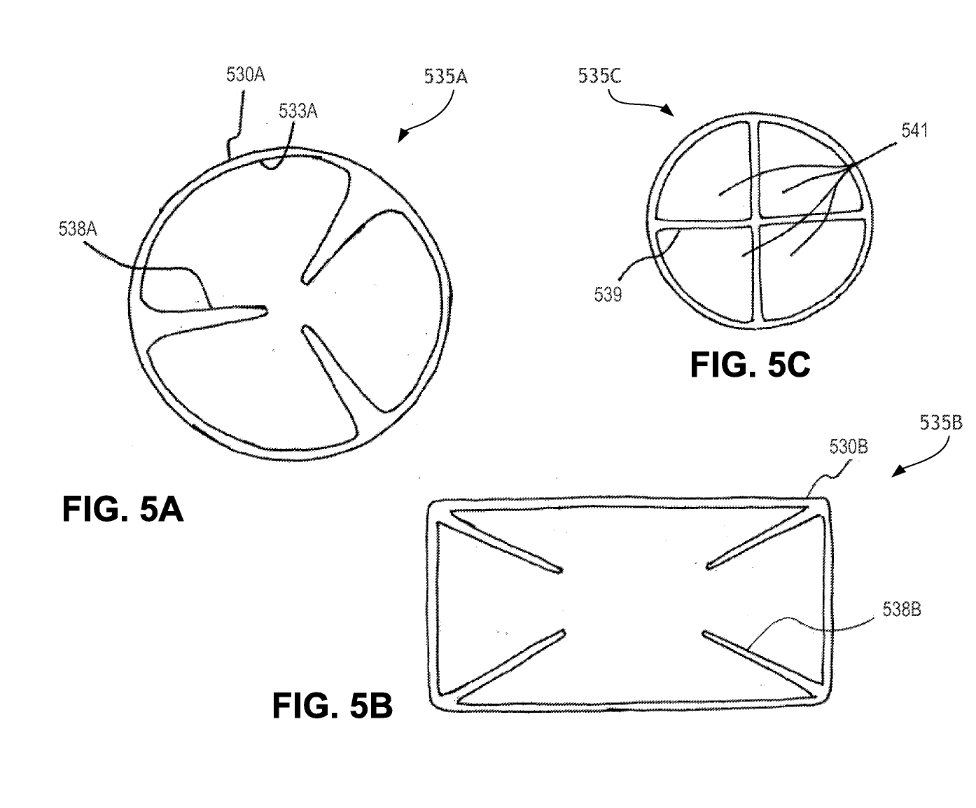

As described above, the walls of the heating chamber, or portions thereof may be integrated with, or disposed in thermal communication with, heat exchanger structures. For example, the walls of the heating chamber may advantageously comprise thermally conductive material configured to increase the ability of the chamber to conduct heat between the barrier and the internal contents or chamber walls. Therefore, the heating chamber and/or associated structure may include heat sink structures, such as heat fins, or the like. FIGS. 5A-5C provide illustrations of example heat exchanger embodiments. Although certain shapes and/or structures are illustrated, heat exchanger structures may take any suitable or desirable form. The figures provide top-down cross-sectional views of heating chambers.

The chamber 535A shown in FIG. 5A has a substantially elliptical cross-sectional shape, such as a circle. The chamber includes one or more outer walls or surfaces 530A, as well as one or more inner walls or surfaces 533A. In certain embodiments, the outer surface 530A is configured to absorb heat from a heat transfer medium disposed in proximity thereto. The chamber 535A may include one or more heat fin structures 538A projecting inwardly from the interior surface 533A towards a center point, or in some other direction generally away from the point of origin of the fin. The chamber may include any number of heat exchangers. In certain embodiments, the one or more heat fins are of a shape and/or size as to not be overly obstructive with respect to containment and/or mobility of contents within the chamber for the containers intended purposes. In certain embodiments, one or more internal walls provide indicators as to volume or other content measurements.

FIG. 5B illustrates an embodiment of a substantially rectangular container. The structure 535B has heat fins projecting from one or more corners of the internal walls of the chamber. Heat fins may additionally or alternatively project from one or more sidewall portions, or be designed in any desirable number or configuration. FIG. 5C shows a chamber 535C having heat exchanger portions that connect to form sub regions 541 at one or more points along the height of the chamber. For example, the fins 539 may be relatively shallow with respect to the height of the chamber, wherein the fins form a grate or other structure that is configured to break up soluble contents within the chamber when the container is agitated. Such a structure may provide dual benefits of heating and stirring/mixing with respect to certain formulas or powders. In other embodiments, the fins 539 may extend to the bottom of the chamber, wherein the fins form sub chambers for holding segregated volumes of heating content when the chamber is filled to a certain capacity and positioned in a generally vertical orientation. Such an embodiment may provide increased surface area for improved heat transfer.

In certain embodiments, a chamber structure and/or heat fin includes or is associated with material having high emissivity characteristics. Such characteristics may encourage efficient transfer of thermal energy from the structure to the internal cavity of the container. For example, a high-emissivity layer, film, coating, paint, or other structure or substance may be integrated with and/or disposed in thermal contact with, the chamber structure, thereby increasing the rate at which thermal energy may be drawn from the structure in certain conditions.

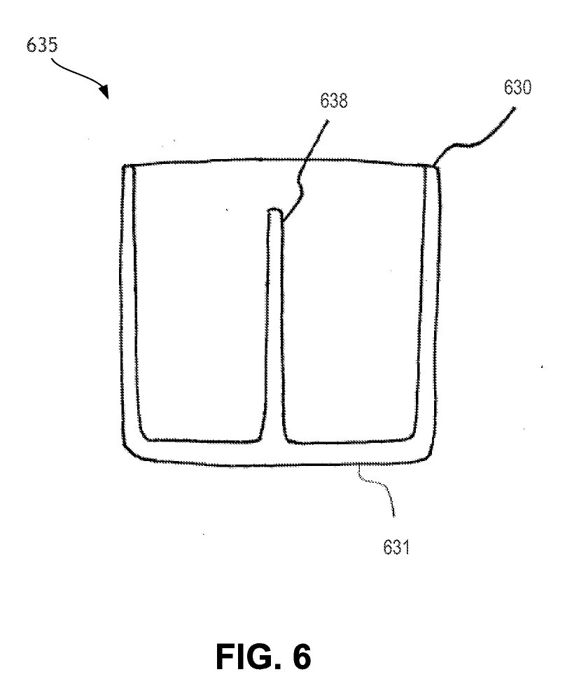

Although FIGS. 5A-5C show heat exchanger structures generally protruding from a side surface of the chamber structure, a radiation shielding container may additionally or alternatively include one or more heat exchanger structures protruding generally from a bottom surface or other surface. FIG. 6 illustrates a cross-sectional view of an embodiment of an internal chamber structure 635. The structure 635 includes a heat exchanger generally protruding from a bottom portion 631 of the structure. In certain embodiments the structure is formed to allow for heat transfer medium, as well as portions of the internal chamber structure, to protrude towards the center of the chamber. For example, extension of heat exchanger structure into the chamber may provide a concavity with respect to the outside of the chamber structure, such that the concavity may be filled with a heat transfer medium.

### Radiation Barrier

A radiation-shielding container, as described in certain embodiments herein, may advantageously include a radiation shield, or barrier, configured to at least partially protect internal contents of the container from direct exposure to microwaves. FIG. 7 is a perspective view of an embodiment of an internal chamber 735 associated with a radiation barrier 720. The barrier 720 shown in FIG. 7 may comprise a sheet, mesh, or layer of metal or other conductive material. In certain embodiments, the barrier 720 comprises a conductive paint or coating, such as copper, gold, aluminum, or other type of paint or coating. In certain embodiments, the conductive barrier 720 is integrated with the structure 735. For example, the internal chamber structure 735, itself, may be configured to act as a radiation barrier. In certain embodiments, the radiation barrier is a metal or other conductive material, such as a polymer/plastic having a concentration of electrically conductive substance integrated therewith.

Certain conductive materials may react adversely to direct exposure to microwave radiation of a given strength. For example, metal objects that form or include thin, poorly conductive portions (e.g., certain foil or thin wire structures), or have pointed regions may respond to a microwave-induced electric field by producing high concentrations of electric charge in regions where electron mobility is constricted. Such collection of charge, under certain conditions, may exceed the dielectric breakdown of air (e.g., about 3 megavolts per meter (3×106 V/m), wherein the air forms a conductive plasma, which can be visible as a spark. However, in certain configurations, metal or other electrically conductive objects may be disposed within a microwave oven during operation without experiencing such effects. For example, the barrier 720 shown in FIG. 7 may comprise a substantially smooth metal object/surface, such that sparking is not produced.

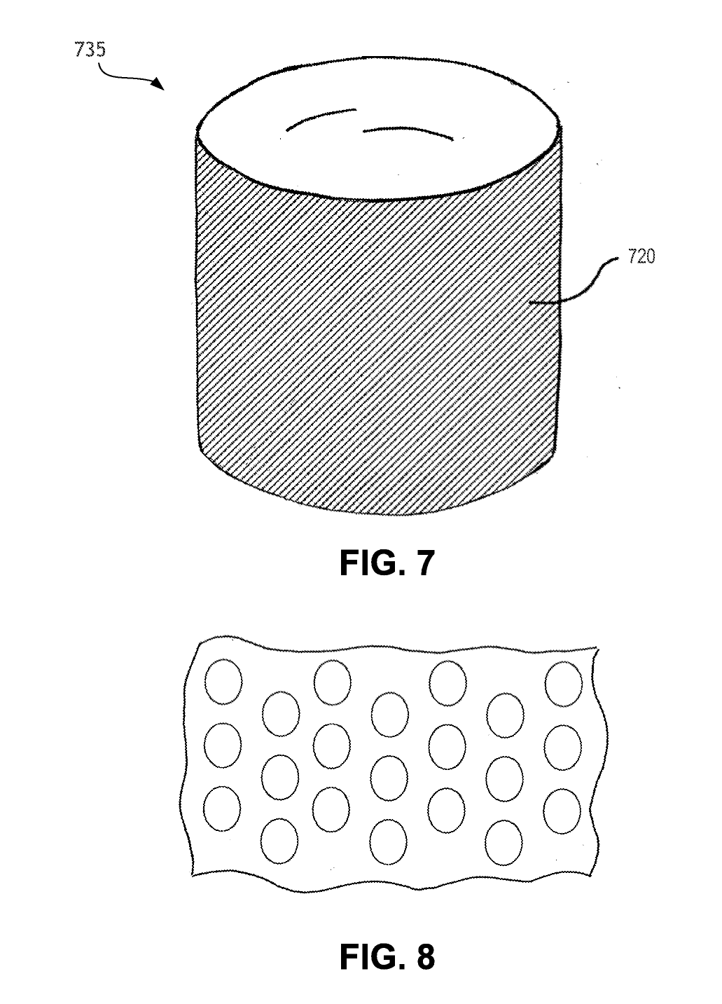

In a similar way, interior wall panels may include perforations that allow a heat transfer medium to occupy space within the perforations and/or pass therethrough. For example, conductive metal/matter formed in a microwave-safe shape. Such metal plates, or sheets, can serve as effective shields to microwave radiation, while potentially allowing for the transmission of, for example, certain fluids through the shield. FIG. 8 is a close-up view of a portion of an embodiment of a radiation barrier having openings therein. The openings may be small enough to allow electrical carriers to redistribute themselves around the openings in such a way as to maintain Faraday shielding characteristics.

In certain embodiments, the radiation shield includes a material configured to effectively absorb microwave energy and reradiate at least a portion of the energy as infrared radiation which can contribute to heating of the heat transfer medium and/or walls of the internal chamber, thereby increasing the transfer of thermal energy to the container's contents. Furthermore, the radiation barrier may reflect radiation back towards the heat transfer medium, thereby increasing the intensity of radiation in portions of the medium.

### Heat Transfer Medium

The heat transfer medium advantageously comprises microwave-absorbing substance, such that exposure to microwave radiation above a threshold level generates heat in at least a portion of the heat transfer medium. Heat generated in the heat transfer medium may be conductively transferred through the medium, such as towards a heat exchanger for transfer of at least a portion of the heat out of the medium.

In certain embodiments, the heat transfer medium is primarily fluid, such as water (e.g., salt water), or microwave-absorbing oil or other liquid. The heat of the medium may be at least somewhat constrained by the maximum achievable temperature of the fluid, which may be governed by the boiling temperature of the fluid. In certain embodiments, the heat transfer medium is a thermally conductive solid that has microwave-absorbing characteristics. For example, the heat transfer medium may comprise a microwave-absorbing ceramic or other material.

With respect to liquids, the potential for heated liquids to reach a boiling point can make it necessary or desirable to provide venting for the liquid due to increased pressure from liquid-to-gas phase change. Therefore, a container may include a slit or other opening providing venting for a liquid heat transfer medium. Furthermore, as liquid changes phase to gas in response to heating above the liquid's boiling point, some amount of gas and/or boiling liquid may exit the container, thereby reducing the volume of heating medium in the container. Therefore, in certain embodiments, the heating medium may be added to the container as desired. For example, the medium may be insertable through a venting slot or aperture. Alternatively or additionally, one or more components of the container may be separable, wherein medium may be added and the respective components recombined prior to heating.

Phase-Change Medium

In certain embodiments, the heat transfer medium may comprise a phase change material, wherein energy generated during medium phase change is provided to head the contents of the container. For example, the medium may have an effective solid-liquid phase change temperature designed to provide a desirable heating temperature point. In certain embodiments, the medium comprises a straight-chain saturated aliphatic fatty acid, or other acid, wax, polymer, or salt hydrate. Furthermore, the medium may comprise molecules of various lengths, such that a volume of the medium melts over a range of temperatures dues to varying molecular lengths of the volume of the medium. For example, a first subvolume of the medium may begin to melt (i.e. transition from solid phase to liquid phase) at a first temperature, and a second subvolumes of the medium may begin to melt at a second temperature. Furthermore, different subvolumes of the medium may have different freezing points. However, the effective phase change temperature of the complete volume of the medium may still be substantially similar to a desirable heating temperature. The phase-change medium may provide for improved retention of temperature of the heating contents of the container due to thermal equilibrium between the medium and the heating contents.

A phase-change medium may have one or more of the following properties: 1) the medium may be substantially solid below the desired temperature; 2) the medium may be substantially liquid above the desired temperature; 3) the medium may have a relatively low specific heat; 4) the medium may have a relatively high heat of fusion; and 5) the heating medium may have a phase change temperature substantially at a desired heating temperature (or within a range of appropriate heating temperatures) of the contents.

Ferrites

Certain mediums will continue to heat without any practical temperature limit being obtainable when subjected to microwave radiation, causing “thermal runaway.” Such a response may generally be due to the dielectric property of the absorbing material or lossy material. As the temperature of the absorbing material increases, the resistance may decrease, thereby allowing the absorbing material to heat under the influence of the electric field portion of the microwave radiation.

Certain microwave absorbing materials, specifically ferrites (wherein iron is a component), have a Curie temperature which is readily measurable. Absorbing materials that exhibit Curie temperature properties may present an upper temperature limit, of about the Curie temperature, which may be attainable when exposed to microwave radiation. Certain embodiments disclosed herein provide for use of a heat transfer medium in a microwave heating container configured to heat under the influence of the microwave radiation up to an upper temperature limit, at which temperatures the medium may substantially cease to absorb microwave energy. For example, a heat transfer medium utilized in one or more of the containers described herein may comprise ferrites having a Curie temperature at or near a desirable heating temperature for a particular application. In certain embodiments, temperature limiting may be achieved by selecting an appropriate DC volume resistivity for the medium, as measured at room temperature, and by selecting the thickness of the material within a prescribed range.

Generally, ferrite materials may exhibit both magnetic permeability and dielectric permittivity in which heating of the absorbing medium by microwave radiation absorption can be accomplished both by the magnetic field component of the microwave radiation and the electrical field component of the microwave radiation. By appropriately choosing a sufficiently high resistance to prevent the absorbing medium from becoming a semiconductor during heating and by selecting an appropriate medium thickness, heating of the medium by the electric field component may be substantially eliminated.

The heat transfer medium may include one or more materials having ferromagnetic or ferrimagnetic properties, a Curie temperature and an ability to heat when exposed or subjected to microwave radiation. Such materials may include, for example, magnetic oxide materials that are known as ferrites and that belong to one of three crystallographic classes: garnets, spinels and hexagonal ferrites. In certain embodiments, the heat transfer medium comprises one or more spinels, such as NiO.Fe₂O₃ and hexagonal ferrites such as BaO.6Fe₂O₃, crystalline or polycrystalline, pure or as part of a mixture that is prepared as single or multiple ceramic piece, and/or one or more other divalent metal oxides, such as BaO.MgO.3Fe₂O₃.

Certain embodiments disclosed herein provide for a heat transfer medium having dispersed therethrough relatively highly-reactive particles that are configured to absorb microwave energy. For example, such particles may comprise ferrites, which, as described above, may have relatively high electrical resistivity that distinguish them from magnetic metals. In certain embodiments, ferrites utilized have Curie points in the range of about 80° C. to over 200° C. In certain embodiments, one or more layers of ferrite medium provide both heat absorbing and radiation shielding functionality. That is, a ferrite medium may at least partially provide the functionality of the radiation shield 120A and the heat transfer medium 110A described above.

Other Mediums

Certain embodiments disclosed herein utilize one or more other types of microwave-absorbing heat transfer mediums. For example, certain materials containing some amount of water content may be used. In an embodiment, rice or another grain is used, which may have desirable water content and/or thermal capacity for certain applications. Such materials may be subject to burning under certain heating conditions, and therefore may be more suitable in lower heat applications. In addition, various microwave-absorbing gels may be used. Venting of such mediums may or may not be necessary depending on the heating conditions. For example, where thermal expansion and/or liquid-to-gas phase change may occur, venting may be desirable to avoid bursting or other undesirable effects.

The presence of the heat transfer medium in the microwave oven during operation may also advantageously provide adequate microwave-absorbing substance to prevent the formation of standing waves within the internal chamber of the microwave oven. Under certain conditions, without adequate microwave absorption, microwave energy may be reflected back and forth between the tube and the cooking chamber, which may cause the tube to overload and burn out. In certain embodiments, issues associated with standing wave formation are at least partially alleviated by the absorption of microwave radiation by the medium. In certain embodiments, it may be desirable to utilize a heat transfer medium comprising some amount of fats and/or oils in order to reach temperatures higher than the boiling point of water.

### Baby Bottle Embodiment

Certain embodiments of radiation-shielding containers are configured to heat consumable liquids, such as baby formula or milk. Use of a radiation-shielding container for such purposes may be desirable for various reasons. For example, heating breast milk using microwaves can cause nutritional changes in the milk, wherein protective properties of the milk may be diminished or destroyed. Furthermore, microwaving certain baby formulas may result in a loss or breakdown of vitamins and/or proteins. Milk heated by microwaves to a high enough temperature can cause portions of the milk to lose a substantial portion of contamination-resistive properties. Nutrition of babies is often a significant concern when it comes to selection and preparation of baby food in order to support mental and/or physical development. The formation of hot spots in baby food can also be a concern due to the danger of burns to babies. Heating of formula or milk using a microwave shielding container may decrease or eliminate the risk of hot spots.

In addition, preparation of baby food can be a time-sensitive exercise, as children can respond negatively to prolonged waiting for food. Therefore, the convenience of being able to heat baby formula or milk in the microwave, while maintaining the health benefits of certain non-microwave heating methods, can make the use of microwave shielding containers, as described herein, desirable for such purposes.

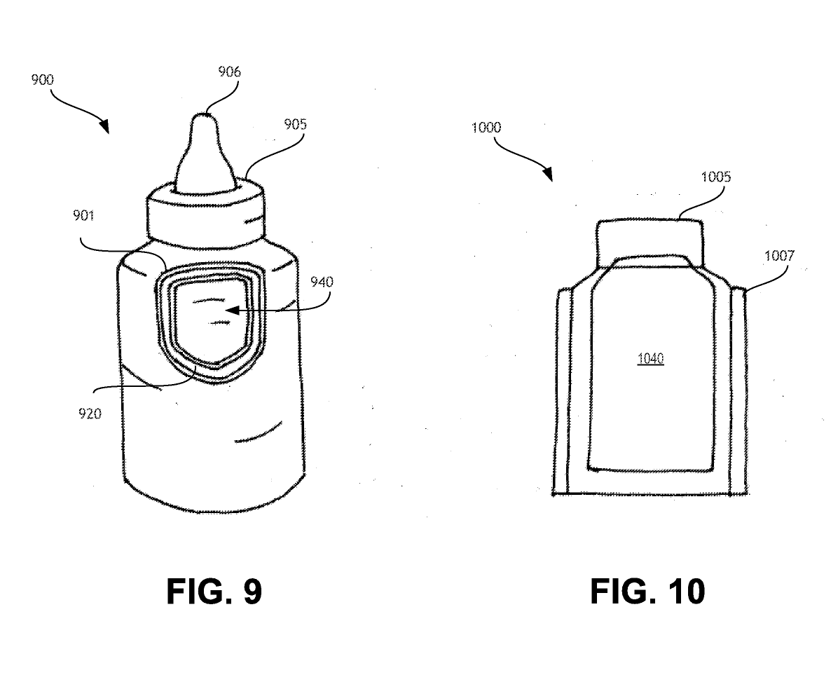

FIG. 9 illustrates a perspective cut-away view of a bottle 900 having radiation-shielding characteristics, as described herein. The cut-away portion 901 shows an internal area 910 in which a heat transfer medium may be disposed. The cut-away 901 further shows an internal heat exchanger 930 having a radiation barrier 920 adjacent thereto and at least partially enclosing a cavity 940 configured to hold liquid, such as formula or milk.

The bottle 900 may include a lid member 905. In certain embodiments, the lid also has radiation-shielding properties in order to protect the internal cavity from radiation when the lid is engaged with the bottle. The lid may include a nipple portion 906 for expressing liquid from the bottle. In certain embodiments, a first lid type is used during heating, wherein the lid does not include a nipple member or structure for attaching a nipple thereto. The first lid type may be used for heating and replaced with a second lid type that may be associated with a nipple member for use during feeding.

FIG. 10 is a cross-sectional view of a baby bottle embodiment having a lid portion 1005 and an insulator portion 1007 associated with at least a portion of the exterior of the bottle. In certain embodiments, the insulator portion 1007 is at least partially transparent to microwave radiation to allow for radiation to pass therethrough and heat a heat transfer medium internal to the insulator. For example, the insulator portion 1007 may comprise silicone, such as cooking-grade silicone, wherein the silicone is substantially transparent to microwave radiation. In certain embodiments, the insulator portion 1007 is integrated with the exterior of the container. For example, the insulator portion 1007 may serve to at least partially contain the heat transfer medium on an interior surface of the insulator. In certain embodiments, the insulator portion 1007 is separable from the container 1000.

### Food Poacher Embodiment

Poaching of food is a cooking technique in which boiled water is used to cook the food, providing a particular texture and/or consistency, among other features. For example, certain poaching techniques involve placing a food container in boiling water or other liquid. To some, the texture and/or other properties of poached food may be desirable over microwaved food in certain situations. However, poaching can be more cumbersome than microwaving in certain respects. Furthermore, poaching can introduce burn risks that are not as serious with microwave cooking. Therefore, certain radiation-shielding containers are configured to provide a mechanism for poaching food in a microwave without allowing for the microwave radiation itself to cook the food.

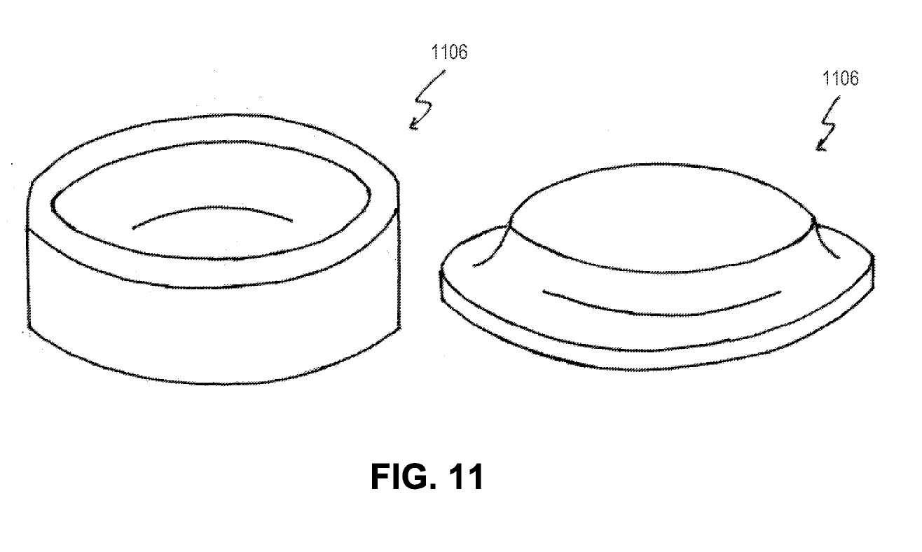

Certain embodiments of radiation shielding poaching apparatuses, for example, can be used for poaching eggs. FIG. 11 illustrates a perspective view of an embodiment of an egg-poaching container in accordance with certain features disclosed herein. While the container 1100 shown includes a single chamber 1140 for cooking food, such as one or more eggs, certain embodiments include a plurality of cooking chambers. An increased number of chambers may allow for greater cooking capacity. One or more eggs may be cracked and placed within the chamber 1140 and placed in a microwave oven, wherein the microwave radiation heats water or other microwave-absorbing liquid or substance contained within an internal cavity of the container, as described above, such that the water or other substance may heat the contents through conduction and/or convection, thereby providing poaching functionality.

The container 1100 may include a radiation shield and heat exchanger for shielding the contents from the radiation and transferring heat to the contents. In certain embodiments, the radiation shield, food-holding structure and/or heat exchanger may be integrated. For example, the container may include a metal cup or other structure which shields the contents from radiation. Furthermore, the metal cup (e.g., aluminum) can be highly thermally conductive, providing heat-transfer functionality. The cup may include heat fins, or other heat transfer conducive structure, and may likewise serve to hold the heating contents. The container 1100 may be suited to cooking egg patties for use in a sandwich or other food item, wherein the cooked egg is poached, as opposed to microwaved or grilled, potentially providing more desirable texture or other properties.

While the poaching container 1100 is generally elliptical in cross-sectional shape, poaching containers may be any suitable or desirable shape or form. FIG. 12 illustrates a perspective view of an embodiment of a rectangular food-poaching container in accordance with certain features disclosed herein. Food poaching containers may be utilized for cooking various types of food or other content, such as soups, drinks, solids, sauces, etc. In certain embodiments, contents containing some amount of liquid may allow for more efficient heat transfer between the heat exchanger and the contents.

### Controlled Cooking

Certain embodiments disclosed herein provide for utilization of temperature-specific heating medium with radiation shielding functionality to provide controlled-temperature cooking. For example, some embodiments may substantially simulate sous-vide, or other similar cooking methods, wherein vacuum-sealed heating contents are heated with a heating medium having a temperature limit lower (or higher in certain embodiments) than normally used for cooking, such as between approximately 55-70° C., or other temperature. Such embodiments may provide desirable texture/moisture characteristics in the heating contents.

### Defrosting

Certain embodiments provide for heating of frozen, or partially frozen, contents using microwave radiation. Such embodiments may utilize a heat transfer medium having a freezing point below standard temperatures experienced in domestic and/or commercial freezer devices. For example, the medium may have a freezing temperature substantially below −18° C., such as below −23° C., or lower. Unlike certain frozen contents, which may not be immediately responsive to microwave heating due to the frozen water molecules contained therein, defrosting container embodiments may allow for the heat transfer medium to be heated substantially immediately in an operating microwave oven, which may then heat the contents through thermal conduction or other mechanism. Such containers may provide for defrosting functionality with or without radiation shielding of the container. In certain embodiments, heating of the contents is achieved through indirect heating by the heat transfer medium as well as through direct heating of the contents using microwave radiation. The speed of defrosting may be substantially increased in certain embodiments.

### Example Embodiment

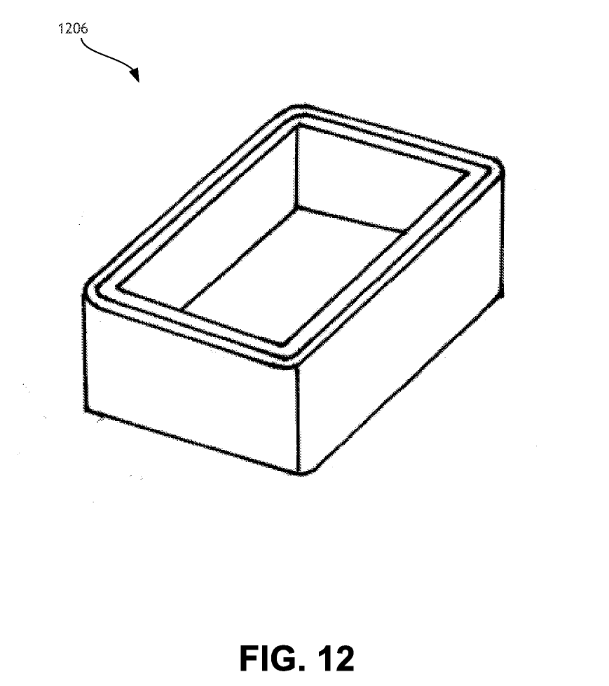

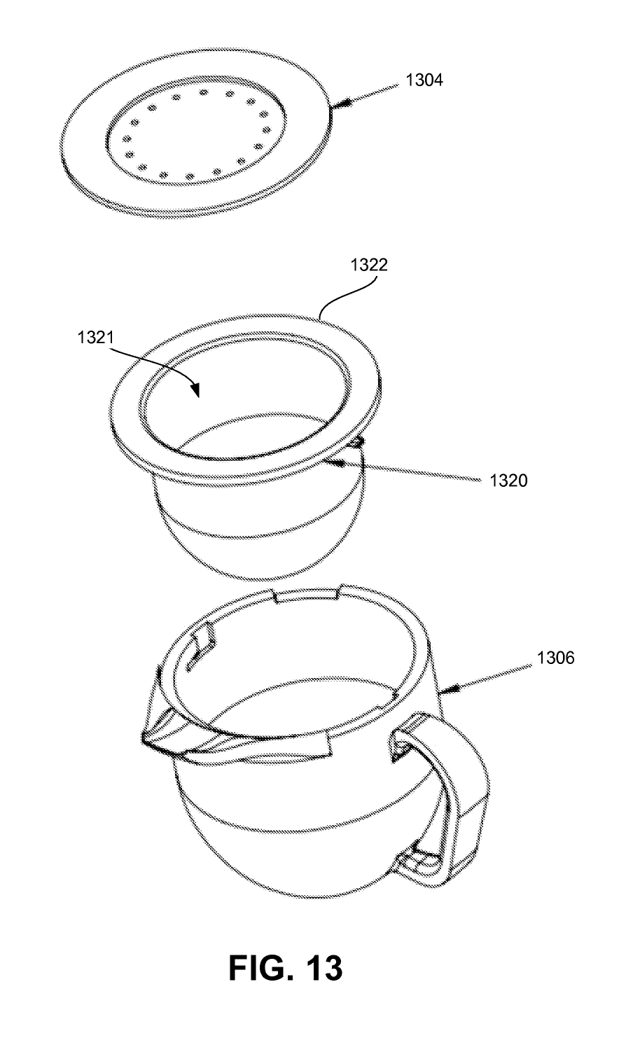

FIG. 13 illustrates a perspective view of components of an embodiment of a radiation-shielding container 1300 including a plurality of components. FIG. 13 shows an outer cup portion 1306, an inner cup portion 1320 and a lid portion 1304. In certain embodiments, the inner cup portion 1320 is configured to be disposed at least partially within the outer cup portion 1306. Furthermore, the lid portion 1304 may be configured to at least partially cover an opening 1321 of the inner cup 1320. The inner cup 1320, in combination with the lid 1304, may serve to shield contents contained within the inner cup at least partially from electromagnetic radiation in certain embodiments. The outer cup 1306 may be configured to hold a heat transfer medium, such that when the inner cup 1320 is nestingly disposed within the outer cup 1306, at least part of the heat transfer medium is in thermal communication with an outside wall or portion of the inner cup 1320. In certain embodiments, the outer cup 1306 is at least partially transparent to microwave radiation. Furthermore, the outer cup may have good thermal insulation properties, such that when a hot heat transfer medium is disposed therein, the outer cup does not cause significant risk of burn to one touching the outside surface of the cup. In certain embodiments, the components 1304, 1320 and 1306 are removable from one another, thereby providing for independent cleaning of the various components.

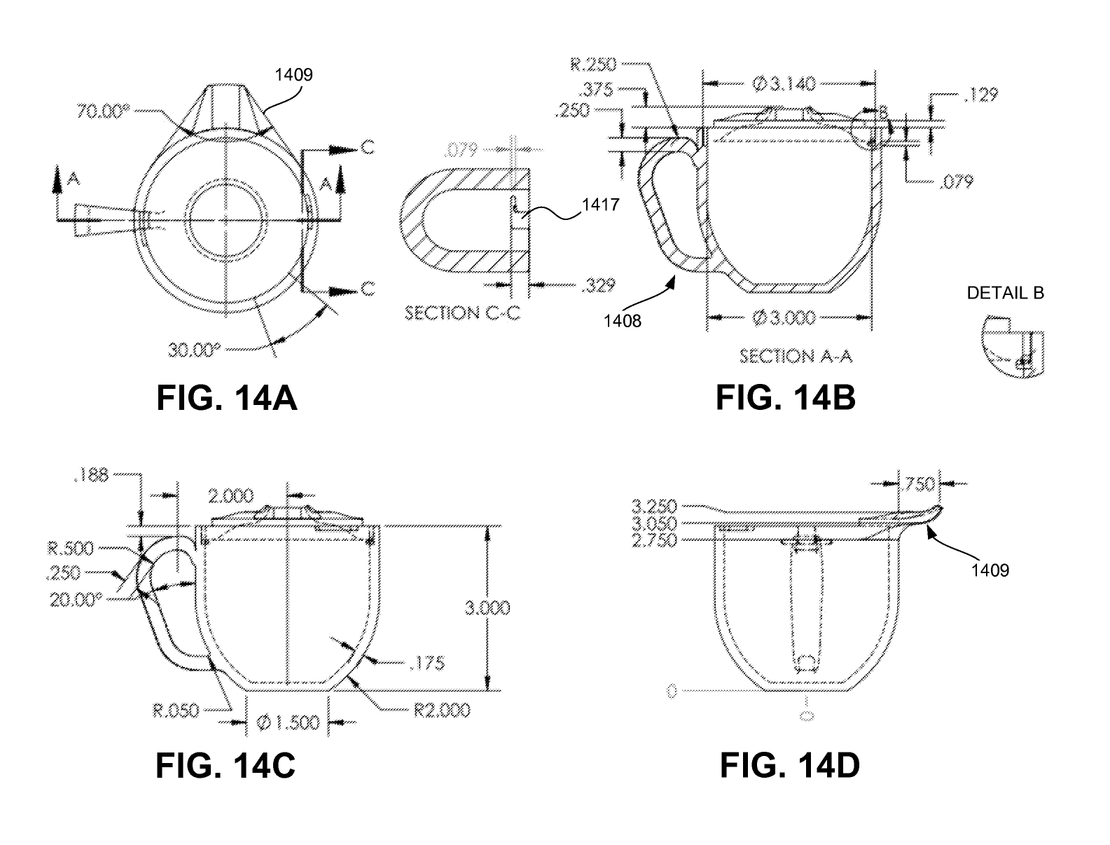

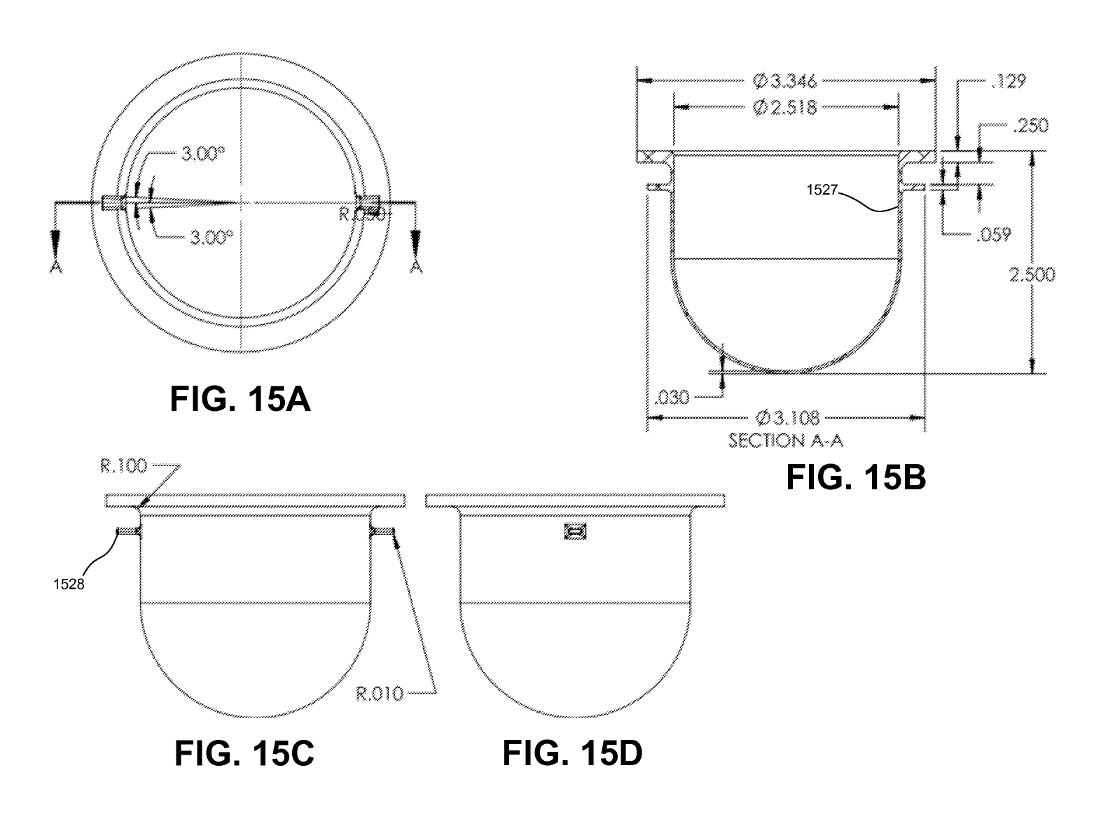

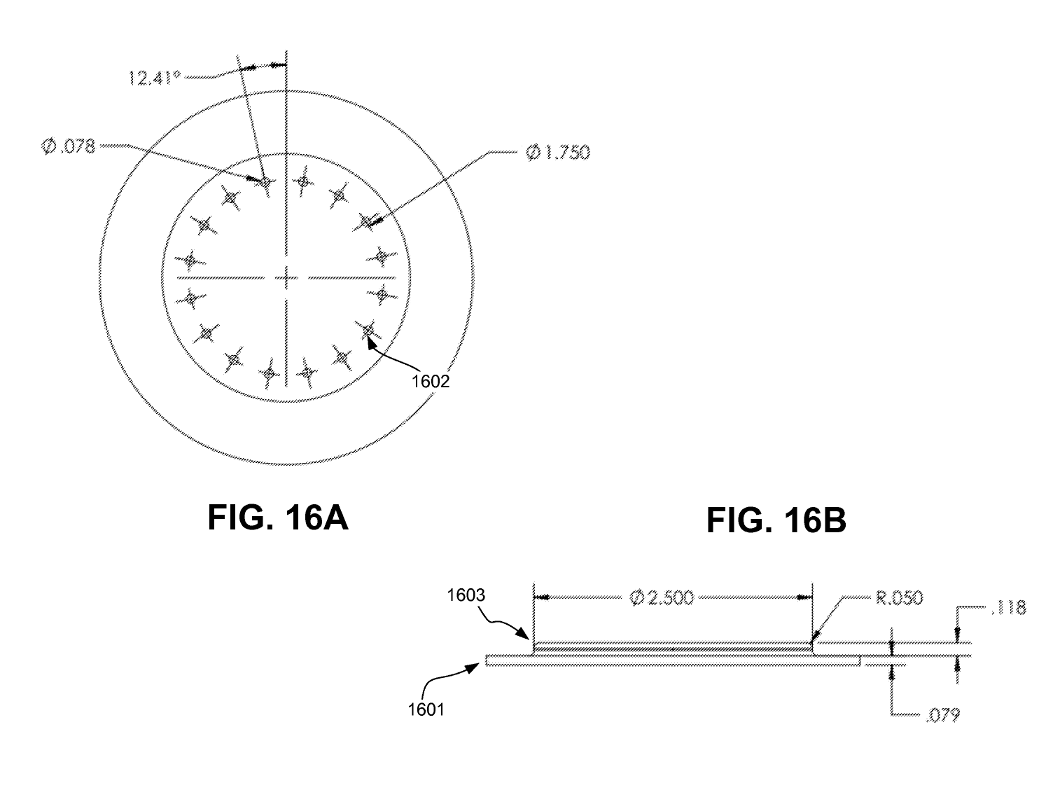

FIGS. 14A-14D illustrate various views of an outer cup portion of a radiation-shielding container according to one or more embodiments. Although the illustrated views of FIGS. 14A-14D, as well as those of FIGS. 15A-15D and 16A-16B, provide various dimensions (in inches), such values are provided as examples only, and one or more of such values may be modified as desired or practical in a given design. The outer cup portion may include a gripping handle 1408, which may provide a means for grabbing and/or holding the outer cup. In certain embodiments, the outer cup may contain hot contents (e.g., heat transfer medium), wherein the handle 1408 may reduce the risk of burn or discomfort that may be associated with holding the outer cup by its outer surface.

The outer cup may further include a pour spout 1409. The pour spout may provide for directed pouring of, for example, liquids contained within the inner cup when nestingly disposed within the outer cup. For example, the container 1300 may be used to heat breast milk or infant formula, as discussed above, which may be poured from the container when heated, using the pour spout.

The outer cup may further include one or more securing features for securing thereto an inner cup, such as the inner cup 1320. Since the outer cup may maintain a heat transfer medium, such as a liquid heat transfer medium, between the outer cup and the outer surface of the inner cup, a securing mechanism may be desirable to help contain the heat transfer medium substantially between the two cups. The securing mechanism may further help keep the inner cup attached to the outer cup for preventing the inner cup from becoming separated from the outer cup when pouring from the inner cup or otherwise handling or using the container. The securing mechanism may take on any desirable form, such as groove 1417, which may be configured to receive and/or guide projections or other members associated with the inner cup. The projections may fit within a nested groove that substantially, or at least partially, prevents dislodgement of the cup and/or projections in the absence of directional manipulation by a user.

In another embodiment, the outer cup includes a lip (not shown) configured to be secured above an upper rim of the inner cup as a means of securing the inner cup. For example, the lip may be flexible, such that a user may wrap the lip over the inner cup, or at least a portion thereof, and peel back the lip to disengage the inner cup from the upper cup. In an embodiment, the lip traverses only a portion of the circumference of the outer cup and/or upper rim of the inner cup.

In certain embodiments, the outer cup comprises silicone or other thermally-insulating material. Furthermore, the outer cup may be substantially transparent to microwave radiation. Therefore, microwaves may enter the outer cup and heat the microwave-absorbing heat transfer medium within. In certain embodiments the heat transfer medium comprises water. For example, a user may be able to pour water into the outer cup, either with or without the inner cup secured thereto or nested therein.

FIGS. 15A-15D illustrate various views of an inner cup portion of a radiation-shielding container according to one or more embodiments. In certain embodiments, the inner cup provides radiation-shielding functionality. For example, the inner cup may at least partially comprise metal, such as aluminum, or other electrically-conductive material. The inner cup includes sidewall and base portions. In the illustrated embodiment, the base portion is substantially rounded. However, the base portion may be at least partially flat. The inner cup may advantageously have relatively thin side/bottom walls, to allow for thermal energy to more easily pass therethrough. In an embodiment, at least a portion of the inner surface is coated with a coating that provides one or more of the following functions: increased emissivity for dissipating heat from the inner cup into contents contained therein; non-stick coating, such as polytetrafluoroethylene (Teflon) for preventing heating contents from sticking to the interior wall(s); protective barrier between the inner cup and heating contents which may be desirable in certain configurations; electrical-insulation that can reduce the likelihood of electrical arching between the inner cup and the lid portion (discussed below).

The inner cup may have one or more projections 1528 or other securing mechanism for securing the cup to the outer cup. As described above, the projections 1528 may fit within corresponding grooves of the outer cup. For example, in an embodiment, the projections may be guided within the grooves and rotated to achieve at least partial locking or securing of the projections within the grooves. In certain embodiments, the projections 1528 are absent from the inner cup. Furthermore, one or more other securing mechanisms may be implemented for the purposes of securing the inner cup to the outer cup.

FIGS. 16A-16B illustrate top and side views of a lid portion of a radiation-shielding container according to one or more embodiments. The lid may serve to complete the Faraday cage when combined with the inner cup. Therefore, it may be desirable for the lid, or a portion thereof, to comprise metal or other electrically-conductive material. In certain embodiments, the lid includes one or more apertures 1602, which may provide venting and/or visual access to the contents contained within the inner cup. The aperture(s) may be sized to prevent microwave radiation from propagating therethrough.

In certain embodiments, only a portion of the lid is substantially electrically conductive. For example, a nesting portion, or other bottom portion 1603 may comprise a disc or other-shaped conductive portion, wherein such portion is configured to come within proximity to the inner cup in order to provide shielding functionality together with the cup. It may be desirable for one or more upper portions 1601 to comprise material that is not substantially thermally conductive to at least partially reduce the likelihood of burn or other damage from contact with the lid when the inner cup has hot contents within and/or without its walls. In an embodiment at least a portion of the bottom portion 1603 comprises metal, such as aluminum, whereas at least a portion of the upper portion 1601 comprises plastic, silicone, or other substantially thermally-insulating material.

In certain embodiments, the lid and/or inner cup are designed to prevent electrical arching therebetween when disposed within an operating microwave oven. To such end, interface regions of the lid and/or inner cup may comprise highly electrically-conductive channels to dissuade charges propagating within the lid or inner cup from traversing the distance between them. Such high electrical conductivity may be achieved through structural and/or compositional means. For example, relatively thick conductive channels may be included in one or more of the lid and/or inner cup interface regions, wherein “interface region” refers to regions of the lid and/or cup in close physical proximity to the other of the lid or cup. For example, the lid may contact the cup in one or more regions. In certain embodiments, the inner cup comprises a relatively thick metal or otherwise conductive rim or channel around or near the upper circumference 1322 of the inner cup. The lid may likewise comprise a thick conductive circumferential region. Such configurations may allow for the lid to be nested on the inner cup so as to provide radiation shielding functionality as well as prevent electrical arching.

Reference throughout this specification to “some embodiments,” “certain embodiments,” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used in this application, the terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim requires more features than are expressly recited in that claim. Rather, inventive aspects lie in a combination of fewer than all features of any single foregoing disclosed embodiment.

Although the invention presented herein has been disclosed in the context of certain preferred embodiments and examples, it will be understood by those skilled in the art that the invention extends beyond the specifically disclosed embodiments to other alternative embodiments and/or uses of the invention and obvious modifications and equivalents thereof. Thus, it is intended that the scope of the invention herein disclosed should not be limited by the particular embodiments described above, but should be determined only by a fair reading of the claims that follow.

What is claimed is:

1. A container comprising:
an electrically-conductive inner cup having a sidewall portion and a base portion;
an outer cup configured to be connected to the inner cup, thereby forming an outer chamber between an inside surface of the outer cup and an outside surface of the sidewall portion of the inner cup; and
a lid comprising an electrically-conductive portion, wherein the lid and inner cup form an interior chamber and provide an electromagnetic radiation barrier substantially preventing radiation from a microwave oven from entering the interior chamber when the lid is positioned on the inner cup.

2. The container of claim 1, wherein the outer chamber is configured to receive a microwave-absorbing medium in direct or indirect thermal communication with the sidewall portion, wherein the microwave-absorbing medium is configured to generate thermal energy in response to exposure to microwave radiation of a first power level and a first frequency.

3. The container of claim 2, wherein the microwave-absorbing medium comprises water.

4. The container of claim 3, wherein the microwave-absorbing medium comprises a sodium compound which increases a boiling point of the microwave-absorbing medium.

5. The container of claim 2, wherein the microwave-absorbing medium comprises liquid.

6. The container of claim 2, wherein the microwave-absorbing medium comprises oil.

7. The container of claim 2, wherein the microwave-absorbing medium comprises solid material.

8. The container of claim 1, wherein the lid comprises one or more apertures that allow air to pass out of the internal chamber.

9. The container of claim 1, wherein the inner cup has a substantially elliptical cross-section.

10. The container of claim 1, wherein the outer cup has a thermal conductivity of greater than approximately 2 W/mK.

11. The container of claim 1, wherein the outer cup comprises silicone.

12. The container of claim 1, wherein the inner cup comprises one or more inwardly-projecting heat fins

13. The container of claim 1, wherein at least a portion of an inside surface of the inner cup has a high-emissivity coating disposed thereon.

14. The container of claim 1, wherein the heat transfer medium comprises phase-change material.

15. The container of claim 1, wherein the outer cup comprises a pour spout.

16. A method of heating a substance comprising:
exposing a container to microwave radiation, wherein the container comprises an inner cup containing heating contents in direct physical contact with a sidewall portion of the inner cup and a chamber containing a heat transfer medium in direct physical contact with the sidewall portion;
heating the heat transfer medium with the radiation;
preventing the radiation from penetrating the heating contents; and
heating the contents through the sidewall using the heated heat transfer medium.

17. The method of claim 16, wherein said heating the contents through the sidewall comprises convectively heating the contents using the heat transfer medium in a boiling state.

18. The method of claim 16, further comprising heating the contents through a base portion of the inner cup.

19. An egg-poaching container for use in a microwave oven comprising:
an electrically-conductive inner cup having a sidewall portion and a base portion;
a substantially non-electrically conductive outer cup configured to nestingly receive the inner cup, thereby forming an outer chamber between an inside surface of the outer cup and an outside surface of the sidewall and base portions of the inner cup; and
a lid comprising an electrically-conductive portion, wherein the lid and inner cup form an interior chamber and provide an electromagnetic radiation barrier substantially preventing radiation from a microwave oven from entering the interior chamber when the lid is positioned on the inner cup;
wherein the outer cup and inner cup are configured to be disconnected from one another, thereby allowing for a heat transfer medium to be deposited in the outer cup.

20. The egg-poaching container of claim 19, wherein the outer cup comprises a vent aperture therein for venting gaseous heat transfer medium when the inner cup is nested in the outer cup.
